(19) United States
(12) Patent Application Publication
(10) Pub. No.: US 2024/0344711 A1
(43) Pub. Date: Oct. 17, 2024

(54) LATCH MECHANISM FOR REMOVABLY ATTACHED ACCESSORY IN AN APPLIANCE

(71) Applicant: Haier US Appliance Solutions, Inc., Wilmington, DE (US)

(72) Inventors: Jeffrey Moore, Rock Spring, GA (US); Paul Menzel, Charlotte, NC (US)

(21) Appl. No.: 18/301,919

(22) Filed: Apr. 17, 2023

(51) Int. Cl. F24C 15/16; A47J 27/04

(52) U.S. Cl. CPC F24C 15/16; A47J 27/04; A47J 2027/043

(57) ABSTRACT

A latch assembly for an oven appliance is provided. The latch assembly allows for removable coupling of an oven accessory to a wall of a cabinet of the oven appliance. The latch assembly includes a latch body secured to the wall of the cabinet, a latch arm member, a pin, and a spring wire. The latch arm member has a pin movably engaged with and restricted by a path formed on a surface of the oven accessory. The spring wire engages with the latch arm member to limit movement of the pin within the path. Engaging the oven accessory with the latch assembly allows the pin to be secured within the path to secure the oven accessory to the wall of the cabinet. Re-engaging the oven accessory with the latch assembly allows for the oven accessory to release from the wall of the cabinet.

### FIELD

The present disclosure generally relates to oven appliances, and more particularly to a latch mechanism for removably attaching an accessory, such as a water reservoir, in an oven appliance.

### BACKGROUND

Oven appliances generally include heating elements positioned within a cooking chamber to provide heat to food items located therein. In addition, many oven appliances have “warming” or “holding” features to maintain food items at a safe and sanitary temperature without necessarily continuing to cook. Largely independent of such features included in an oven appliance, the humidity level (e.g., percentage or volume of water vapor present in air) within the cooking chamber can significantly impact the cooking process for foods. Based on the humidity, airflow or moisture may need to be adjusted (or at least accounted for) while the oven appliance is being used to ensure food items are properly cooked and/or kept warm.

Oven appliances may include one or more features for generating steam within the cooking chamber to control the humidity levels during both cooking and warming operations. During cooking operations, for instance, high humidity in the oven may increase the thermal conductivity of the air around a food item, leading to a quicker baking process, whereas low humidity may slow the baking process. Additionally, during warming operations, the quality of a cooked food item tends to deteriorate due to the loss of humidity. Controlling humidity levels can preserve the texture of the cooked food item during such prolonged exposure to warming temperatures.

Steam-generating systems may be provided to generate steam within the cooking chamber to control humidity levels. A steam-generating system generally includes a water source, such as a water reservoir or water line, to provide steam to the oven appliance. Certain challenges exist, however, in the operation of a steam-generating system. For example, it can be cumbersome to connect the oven appliance to the home's water line or the water line may not be proximate to the oven appliance. Thus, using a water reservoir may avoid such issues. However, it is critical to maintain adequate levels of water in the reservoir to ensure enough water is available during the operation of the steam-generating system. In many oven appliances, the reservoir may be permanently or semi-permanently fixed (e.g., welded or bolted) to the oven appliance in a way that makes it difficult to access the reservoir, which is essential for the purpose of resupplying water to the reservoir.

Accordingly, a steam-generating system having an easy-to-remove and/or install reservoir would be welcomed in the art. As such, the present disclosure is directed to a push-to-latch/unlatch mechanism configured to easily secure and release the reservoir within the oven appliance.

### BRIEF DESCRIPTION OF THE INVENTION

Aspects and advantages of the invention will be set forth in part in the following description, or may be obvious from the description, or may be learned through practice of the invention.

In an aspect, the present disclosure is directed to an oven appliance assembly. The oven appliance assembly includes a cabinet, an oven accessory, and a latch assembly. The oven accessory is removably coupled to a wall of the cabinet via a latch assembly. The latch assembly includes a latch body secured to the wall of the cabinet, a latch arm member, a pin, and a spring wire. The latch arm member is coupled to latch body. The pin extends through a distal end of the latch arm member. The pin is movably engaged with and restricted by a path formed on an exterior surface of the oven accessory. The spring wire is configured to engage with a proximal end of the latch arm member to limit movement of the pin within the path. Upon engaging the oven accessory with the latch assembly, the pin of the latch arm member is secured within the path formed on the exterior surface of the oven accessory to secure the oven accessory to the wall of the cabinet in a locked position. Further, upon re-engaging the oven accessory with the latch assembly, the pin of the latch arm member is released from the path formed on the exterior surface of the oven accessory to release the oven accessory from the wall of the cabinet.

In another aspect, the present disclosure is directed to a latch assembly for removably coupling an oven accessory to a wall of a cabinet of an oven appliance. The latch assembly includes a latch body secured to the wall of the cabinet, a latch arm member, a pin, and a spring wire. The latch arm member is coupled to the latch body and extends therefrom. The pin extends through a distal end of the latch arm member. The pin is movably engaged with and restricted by the path formed on the exterior surface of the oven accessory. The spring wire is configured to engage with a proximal end of the latch arm member to limit movement of the pin within the path. Upon engaging the oven accessory with the latch assembly, the pin of the latch arm member is secured within the path formed on the exterior surface of the oven accessory to secure the oven accessory to the wall of the cabinet in a locked position. Further, upon re-engaging the oven accessory with the latch assembly, the pin of the latch arm member is released from the path formed on the exterior surface of the oven accessory to release the oven accessory from the wall of the cabinet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of an oven appliance in accordance with exemplary embodiments of the present disclosure;

FIG. 2 provides an internal, perspective view of the oven appliance of FIG. 1 with a portion of the cabinet of the oven appliance removed to reveal certain internal components of the oven appliance;

FIG. 3 provides a detailed, perspective view of a latch assembly for an oven appliance in accordance with exemplary embodiments of the present disclosure;

FIG. 4 provides a detailed, view of various components of a latch assembly for an oven appliance in accordance with exemplary embodiments of the present disclosure;

FIG. 5 provides a sectional view of a latch assembly for an oven appliance in accordance with an embodiment of the present disclosure; and

FIGS. 6A-6C provide side views of various spring wires of a latch assembly for an oven appliance in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

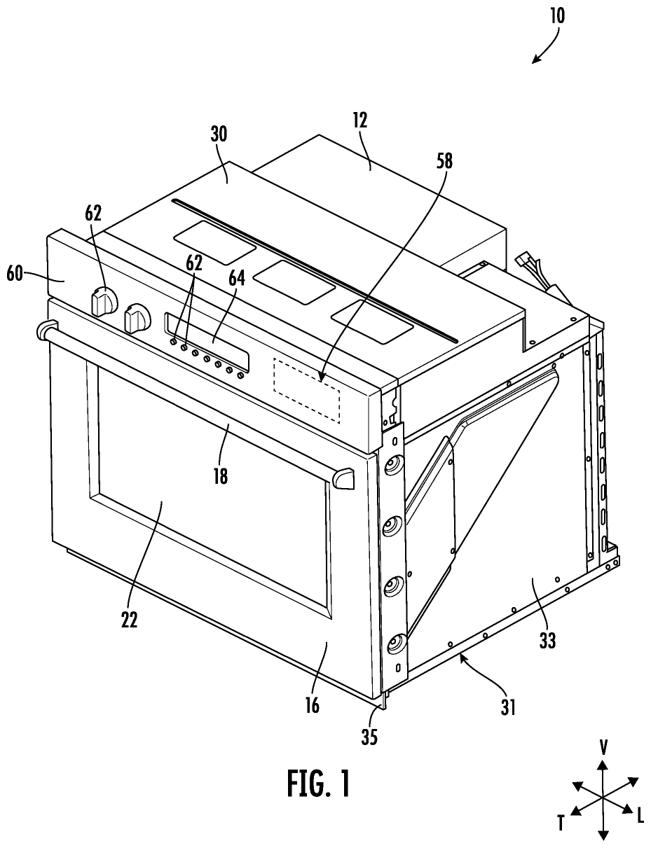

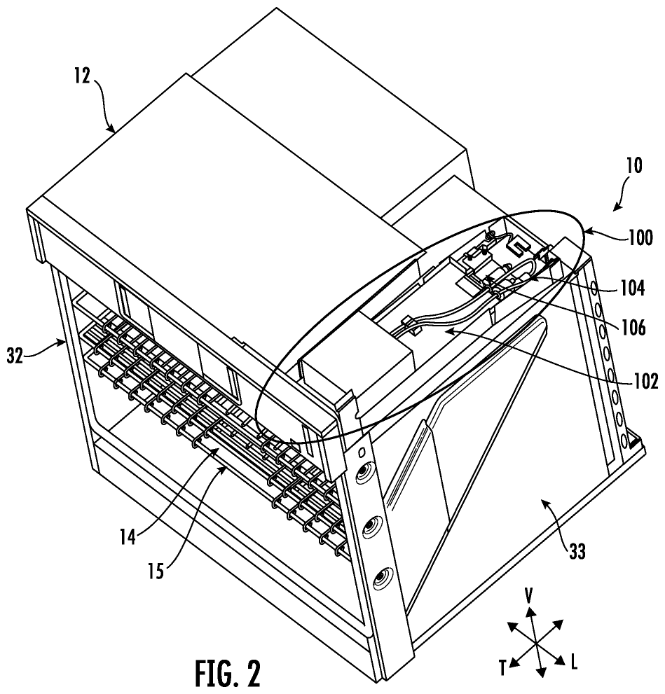

Referring now to the figures, FIGS. 1 and 2 depict an exemplary oven appliance assembly (or “oven appliance”) 10 that may be configured in accordance with aspects of the present disclosure. In particular, FIG. 1 provides a front, perspective view of the oven appliance 10 according to exemplary embodiments of the present disclosure, and FIG. 2 provides an internal, sectional view of oven appliance 10 according to exemplary embodiments of the present disclosure.

For the illustrated embodiment of FIGS. 1 and 2, the oven appliance 10 defines a vertical direction V, a lateral direction L, and a transverse direction T. The vertical, lateral, and transverse directions are mutually perpendicular and form an orthogonal direction system. As will be understood by those skilled in the art, though, the oven appliance 10 is provided by way of example only, and the present disclosure may be used in any suitable cooking appliance. Thus, the present disclosure may be used with other oven appliances having different configurations, such as range appliances, double ovens, etc.

Referring still to FIGS. 1 and 2, the oven appliance 10 includes a cabinet 12 with a cooking chamber 14 disposed within the cabinet 12. The cooking chamber 14 is configured for the receipt of one or more food items to be cooked. The oven appliance 10 includes a door 16 pivotally mounted to the cabinet 12 (e.g., with a hinge—not shown). A handle 18 is mounted to the door 16 and assists a user with opening and closing door 16 in order to access the cooking chamber 14. For example, a user can pull on the handle 18 to open or close the door 16 and access the cooking chamber 14.

The door 16 may include a window 22 constructed, for example, from multiple parallel glass panes to provide for viewing the contents of the cooking chamber 14 when the door 16 is closed and further to assist with insulating the cooking chamber 14. As shown particularly in FIG. 2, a baking rack 15 may be positioned in the cooking chamber 14 for the receipt of food items or utensils containing food items. The baking rack 15 may be slidably received onto embossed ribs or sliding rails such that the baking rack 15 may be conveniently moved into and out of the cooking chamber 14 when the door 16 is open.

As shown in FIGS. 1 and 2, the cabinet 12 may include multiple panels that enclose the cooking chamber 14. For example, as shown in FIG. 1, the cabinet 12 may include a top panel 30 and a bottom panel 31, which are spaced apart along the vertical direction V. As shown in FIG. 2, a left panel 32 and a right panel 33 extend between the top panel 30 and the bottom panel 31, and are spaced apart along the lateral direction L. A rear panel (not shown) may additionally extend between the top panel 30 and the bottom panel 31 as well as between the left panel 32 and the right panel 33. The rear panel is spaced apart from the door 16 along the transverse direction T. When the door 16 is in the closed position, the door 16 may sit flush with a front panel 35 of cabinet 12.

It is understood that the oven appliance 10 may also include heating elements and/or a heating assembly for purposes of heating the chamber 14 to cook and/or clean the oven appliance 10. For example, the heating elements may include a lower heating assembly disposed within the cooking chamber 14, such as adjacent the bottom panel 31. In additional or alternative embodiments, the heating elements include an upper heating assembly adjacent the top panel 30. In yet other embodiments, the heating elements of the oven appliance 10 include a convection heating assembly. The heating elements may be electric heating elements, gas burners, broil heating elements, microwave, or other suitable heating elements or combination thereof having other suitable heating sources.

As illustrated in FIG. 1, in particular, the oven appliance 10 may also be equipped with a user interface panel 60. The user interface panel 60 may represent a general purpose I/O (“GPIO”) device or functional block. In the illustrated embodiment, the user interface panel 60 includes one or more input components or controls 62, such as one or more of a variety of electrical, mechanical or electro-mechanical input devices including rotary dials, push buttons, and touch pads. The user interface panel 60 may include a display component 64, such as a digital or analog display device designed to provide operational feedback to a user to monitor progress of the oven appliance 10.

FIG. 1 also depicts a controller 58 located within the user interface panel 60. In general, the controller 58 may be employed to regulate one or more operations of the oven appliance 10. By way of example, the controller 58 may include one or more memory devices and one or more microprocessors, such as general or special purpose microprocessors operable to execute programming instructions or micro-control code associated with an operating cycle. In such an embodiment, input/output (“I/O”) signals may be routed between the controller and various operational components of oven appliance 10 along wiring harnesses that may be routed through cabinet 12.

Typically, the controller 58 is in operable communication (e.g., wired or wireless communication) with the user interface panel 60 through which a user may select various operational features and modes and monitor progress of the oven appliance 10. Specifically, the controller 58 may be in operable communication (e.g., via a suitable wired or wireless connection) with the one or more controls 62 along with the heating elements, one or more sensors (e.g., humidity sensor, temperature sensor, etc.), and other oven accessories. Thus, in response to user manipulation of user interface panel 60, the controller 58 may selectively control various operations of the oven appliance 10.

Referring particularly to FIG. 2, in an embodiment, the oven appliance assembly 10 may also include one or more oven accessories, such as a steam-generating assembly 100. In such embodiments, the steam-generating assembly 100 may include a water source to direct and/or release water to the insulated cooking chamber 14 for the generation of steam. For example, in an embodiment, as shown, the steam-generating assembly 100 may include a water reservoir 102 removably secured within the oven appliance 10. When secured, the steam-generating assembly 100 further includes a valve 104 configured to connect with the water reservoir 102. Thus, the water valve 104 can be selectively opened, thereby permitting water to flow from the water reservoir 102 and subsequently into the cooking chamber 14. In particular embodiments, the water may be vaporized in the cooking chamber 14 to generate steam (e.g., by the heat generated by the heating assembly). Further, the water reservoir 102 is configured to be removed from the oven appliance 10 to be refilled with water to replenish the amount of water released from the water reservoir 102 during steam generation.

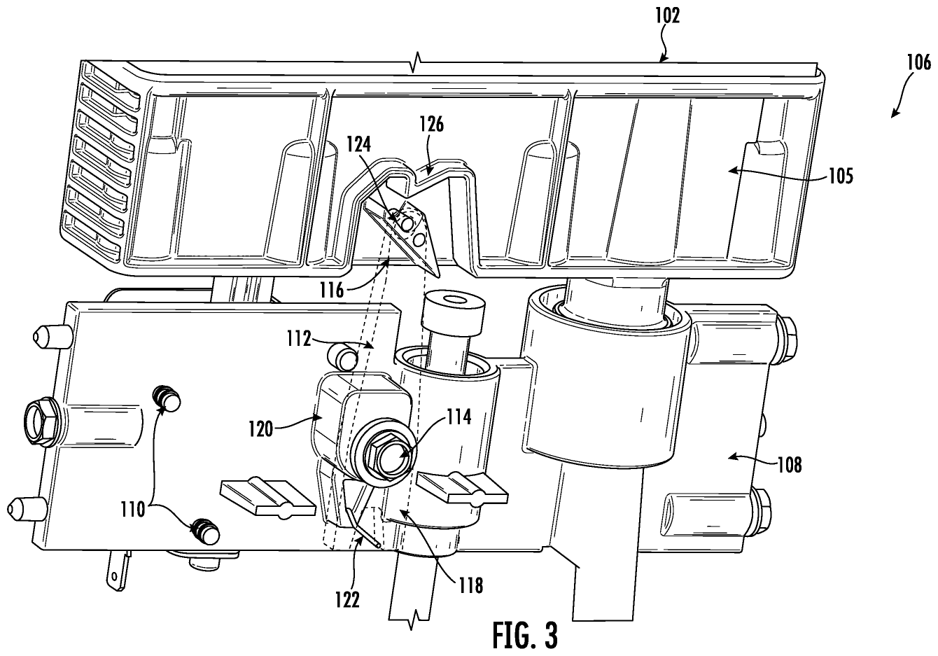

In addition, as shown generally in FIGS. 3-5, the steam-generating assembly 100, or components thereof, may be removably secured within the oven appliance 10 via a latch mechanism 106. In particular embodiments, as shown, the latch assembly 106 may be incorporated with various oven accessories, such as the steam-generating assembly 100 described herein. Further, as shown particularly in FIG. 3, the latch assembly 106 may include a latch body 108 secured to at least one wall of the cabinet 12 of the oven appliance 10. For example, in an embodiment, the latch assembly 106 may be secured to the wall(s) via one or more fasteners 110.

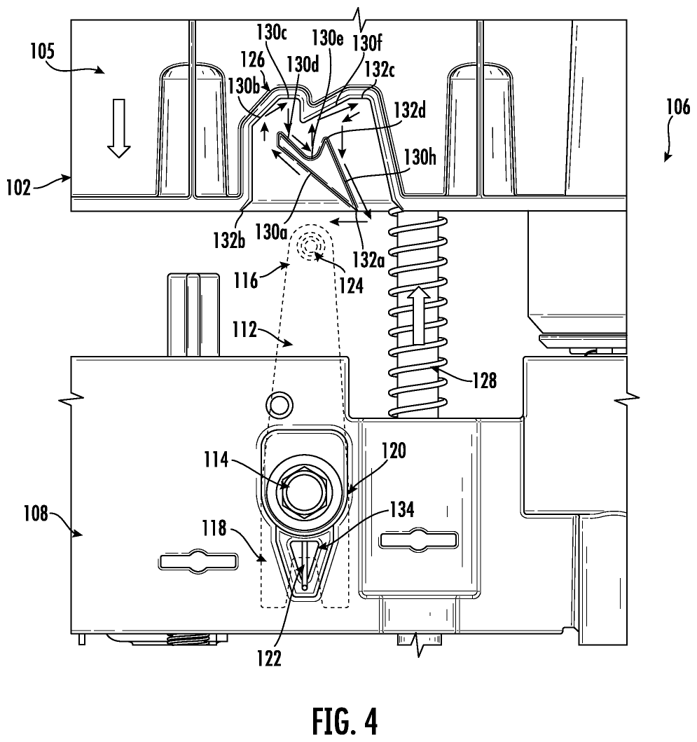

Further, as shown, the latch assembly 106 is operable with one or more oven accessories, such as the water reservoir 102, of the oven appliance 10 to allow for the removable attachment of the oven accessory to the wall(s) of the cabinet 12. Accordingly, as shown in FIGS. 3 and 4, the latch assembly 106 includes a latch arm member 112 coupled to and extending from the latch body 108. In some embodiments, the latch arm member 112 may be secured to the latch body 108 via one or more fasteners 114, which can enable some rotational movement of the latch arm member 112. Further, as shown, the latch arm member 112 has a distal end 116 and a proximal end 118 with the fastener 114 serving as the pivot point between the distal end 116 and the proximal end 118. The rotational coupling between the latch arm member 112 and the latch body 108 allows bidirectional movement of the distal end 116 and the proximal end 118.

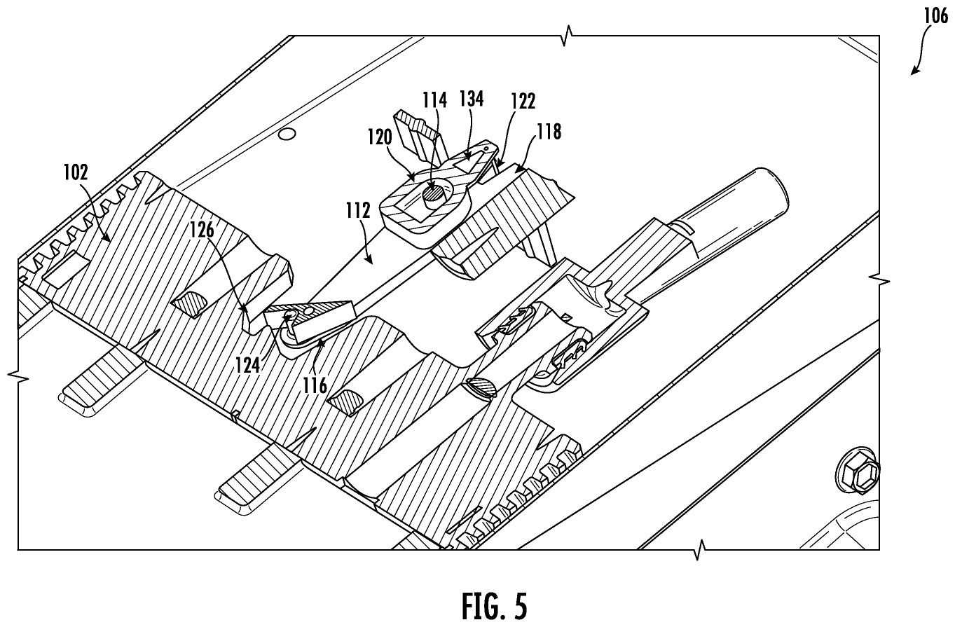

Furthermore, as shown in FIGS. 3-5, the latch assembly 106 includes a pin 124 extending through the distal end 116 of the latch arm member 112. In particular, FIGS. 3 and 5 illustrate the pin 124 in a locked position, whereas FIG. 4 illustrates the pin 124 in an unlocked position. Thus, as shown in FIGS. 3 and 5, the pin 124 is movably engaged with and restricted by a path 126 formed on an exterior surface 105 of the water reservoir 102. Moreover, as shown in FIGS. 3 and 5, the latch assembly 106 includes a spring wire 122 configured to engage with the proximal end 118 of the latch arm member 112 to limit movement of the pin 124 within the path 126. Thus, upon engaging the water reservoir 102 with the latch assembly 106, the pin 124 of the latch arm member 112 is secured within the path 126 formed on the exterior surface 105 of the water reservoir 102 to secure the water reservoir 102 to the wall(s) of the cabinet 12 in a locked position. Further, upon re-engaging the water reservoir 102 with the latch assembly 106, the pin 124 of the latch arm member 112 is released from the path 126 formed on the exterior surface of the water reservoir 102 to release the water reservoir 102 from the wall(s) of the cabinet 12.

In addition, in an embodiment, as shown in FIGS. 3-5, the latch body 108 may include an adapter 120 extending from (or otherwise coupled to) the latch body 108. Thus, as shown, the adapter 120 may generally define an opening 134 through which the spring wire 122 extends. As shown, the spring wire 122 is configured to engage with the proximal end 118 of the latch arm member 112 by extending through the opening 134 in the adapter 120 to limit rotational movement of the latch arm member 112. For example, at least a portion of the proximal end 118 can be characterized by a forked or bifurcated end with the spring wire 122 extending between the bifurcated end of the proximal end 118 of the latch arm member 112. Accordingly, in an embodiment, when the latch arm member 112 is in a neutral position, neither side of the bifurcated end 118 contacts the spring wire 122. From the neutral position, the latch arm member 112 can be biased in a clockwise direction and/or a counterclockwise direction with the fastener 114 serving as the pivot point. Likewise, the distal end 116 and the proximal end 118 of the latch arm member 112 move from the neutral position. The spring wire 122, e.g., being secured by the adapter 120, applies a biasing force to the proximal end 118 toward the neutral position to limit further rotational movement of the latch arm member 112 when the proximal end 118 contacts the spring wire 122. In an embodiment, the opening 134 can be defined proximate the distal end 116 of the latch arm member 112 such that spring wire 122 engages the distal end 116 to limit further rotational movement of the latch arm member 112. In this regard, the spring wire 122 and the pin 124 are both located proximate the distal end 116 of the latch arm member 112.

In alternative embodiments, the proximal end 118 of the latch arm member 112 does not bifurcate. In such embodiments, the latch assembly 106 may include at least two spring wires 122 configured to engage the proximal end 118 to limit rotation of the latch arm member 112. For example, the two spring wires 122 extend through the opening 134 of the adapter 120. The opening 134 may be configured to receive the two spring wires 122 in a spaced apart manner. Accordingly, the two spring wires 122 are spaced apart and extend through the opening 134 with the proximal end 118 of the latch arm member 112 disposed therebetween. In this way, the two spring wires 122 engage the proximal end 118 to limit rotation of the latch arm member 112.

In some embodiments, as shown in FIGS. 4 and 5, the opening 134 of the adapter 120 may have any suitable cross section such that the spring wire 122 limits movement of the pin 124 within the path 126, e.g., by being limited by the cross section of the opening 134. For instance, the cross section of the opening 134 can have a shape that defines a generally triangular cross section, a generally cylindrical cross section, or a generally polygonal cross section. In this way, the spring wire 122 allows for some free rotation of the latch arm member 112 before engaging the proximal end 118 and limiting movement of the pin 124. In some configurations, the spring wire 122 biases the proximal end 118 of the latch arm member 112 toward the neutral position to limit rotation of the pin 124 to less than 45 degrees from the neutral position.

In additional embodiments, as show in FIG. 4, the latch assembly 106 may also include a spring-loaded push rod 128 configured to apply a spring force against the water reservoir 102, and thus biases the water reservoir 102 away from the latch body 108 of the latch mechanism 106. In the locked position, however, the push rod 128 secures the pin 124 of latch arm member 112 within the path 126 to secure the water reservoir 102 to latch body 108, as will be discussed in further detail below.

As shown in FIG. 4, the path 126 formed on the exterior surface 105 of the water reservoir 102 includes a plurality of surfaces 130a, 130b, 130c, 130d, 130e, 130f, 130g, and 130h. For purposes of describing the plurality of surfaces 130a-130h, reference will be made to certain points along the path 126, such as points 132a, 132b, 132c, and 132d. Further, terms such as “left” and “right” are used herein to identify the relative position of certain features defined within the path 126. However, such terms as used herein do not limit the relative configuration of the path 126 or the plurality of surfaces 130a-130h formed therein.

Still referring to FIG. 4, the path 126 includes an inlet defined between the points 132a and 132b through which the pin 124 of the latch arm member 112 enters the path 126 when the water reservoir 102 is engaged (e.g., pushed) with the latch mechanism 106. Moreover, as shown, in an embodiment, at least one of the plurality of surfaces of the path 126 may include a recess 130e for securing the pin 124 within the path 126, thereby securing the water reservoir 102 in the locked position. In addition, the path 126 defines an outlet through which the pin 124 exits the path 126, thereby releasing the water reservoir 102 from the latch mechanism 106. Further, as shown in FIG. 4, the point 132a separates the outlet from the inlet of the path 126.

As the water reservoir 102 is engaged (e.g., pushed) toward the latch mechanism 106, the pin 124 enters through the inlet of the path 126 and movably engages with the path 126 upon contacting surface 130a. The pin 124 is then configured to slide along the surface 130a, which guides the pin 124 toward the surface 130b. The pin 124 then contacts and slides on the surface 130b, which guides the pin 124 toward surface 130c that restricts movement of the pin 124 along the path 126. In particular, the surface 130c is characterized as a terminal surface because surface 130c stops the pin 124 from passing through the path 126 any further, and thus, the water reservoir 102 cannot be pushed toward the latch body 108 any further.

When force is no longer applied to engage the water reservoir 102 toward the latch mechanism 106, the spring force of the push rod 128 biases the water reservoir 102 away from the latch mechanism 106, causing the pin 124 to contact and slide on the surface 130d until the pin 124 reaches the surface 130e. As described above, the surface 130e comprises the recess 130e of the path 126, which is configured to secure the pin 124 within the path 126. The spring force of the push rod 128 pushes the recess 130e against the pin 124 to keep the latch arm member 112 engaged within the path 126 to secure the water reservoir 102 to the latch mechanism 106 in the locked position.

Upon re-engaging (e.g., repushing) the water reservoir 102 toward the latch body 108 of the latch mechanism 106, the pin 124 contacts and slides on the surface 130f until the pin 124 reaches the point 132c. The spring wire 122 contacts a side of the bifurcated portion of the proximal end 118 when the pin 124 is to the right of the point 132c, but before the pin 124 is to the right of the point 132a. When the user stops applying force, the pin 124 slides along the surface 130f toward the point 132d until the spring wire 122 is no longer exerting a force on the side of the bifurcated portion of the proximal end 118. In addition, in an embodiment, when the user stops applying force, the push rod 128 ejects or releases the water reservoir 102 from the latch mechanism 106. As the push rod 128 biases the water reservoir 102 away from latch mechanism 106, the pin 124 contacts and slides along the surface 130h. When the pin 124 exits beyond the point 132a, the spring wire 122 is configured to move the pin 124 to the left of the point 132a to the neutral position.

Accordingly, the spring wire 122 is configured to engage with the proximal end 118 of the latch arm member 112 to limit movement of the pin 124 within the path 126. In other words, upon engaging (e.g., pushing) the water reservoir 102 toward the latch mechanism 106, the pin 124 of the latch arm member 112 is secured within the path 126 formed on the exterior surface 105 of the water reservoir 102 to secure the water reservoir 102 to the wall(s) of the cabinet 12 in a locked position. Upon re-engaging (e.g., repushing) the water reservoir 102 toward the latch mechanism 106, the pin 124 of the latch arm member 112 is released from the path 126 formed on the exterior surface 105 of the water reservoir 102 to release the water reservoir 102 from the wall(s) of the cabinet 12.

Further, the spring wire 122 limits movement of the pin 124 within the path 126 to ensure the pin 124 is positioned to enter the inlet of the path 126 and into the locked position upon pushing the latch assembly 106 via the water reservoir 102. Movement of the pin 124 is guided by the plurality of surfaces 130a-130h until the pin 124 contacts the first terminal surface 130c of the path 126. The first terminal surface 130c stops movement of the pin 124 within the path 126 to ensure the pin 124 is positioned to engage with the recess 130e of the path 126. The spring wire 122 further limits movement of the pin 124 within the path 126 to ensure that the pin 124 exits the path 126 upon repushing the latch assembly 106. In this way, movement of the pin 124 is guided by the plurality of surfaces 130a-130h until the pin 124 contacts the second terminal surface of the path 126 defined by point 132c. The second terminal surface 132c stops movement of the pin 124 within the path 126 to ensure the pin 124 is positioned to exit through the outlet of the path 126. In an embodiment, the path 126 described herein may have any suitable shape, such as a carotid shape, a cordiform shape, or an asymmetrical open-loop shape.

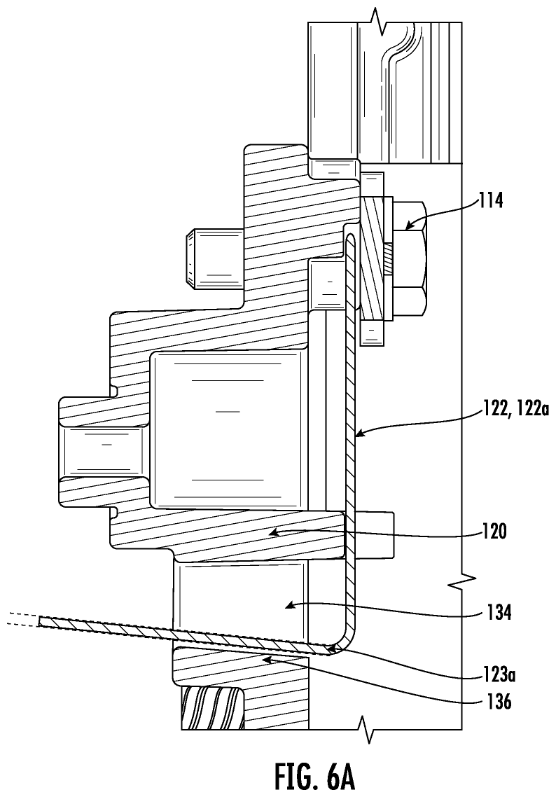

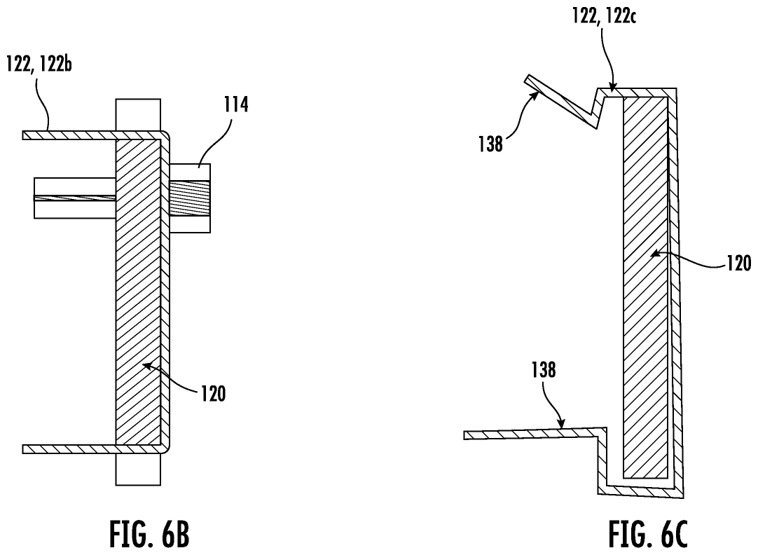

Referring now to FIGS. 6A-6C, side views of various spring wires 122 of the latch assembly 106 for the oven appliance 10 in accordance with embodiments of the present disclosure are illustrated. In particular, as shown in FIG. 6A, the spring wire 122 is a straight section spring wire 122a having at least one straight section 123a received through the opening 134 in the adapter 120. In such embodiments, the straight section spring wire 122a uses compression of the straight section 123a to force the spring wire 122 into the adapter 120. Specifically, in an embodiment, the straight section 123a is forced into a vertex 136 (or stop) of the opening 134 of the adapter 120. In an embodiment, the spring wire 122a can also be secured by being wrapped around the fastener 114. FIG. 6B illustrates another embodiment of the spring wire 122, 122b that uses tension of the spring wire 122b to maintain the spring wire 122b centrally within the opening 134 of the adapter 120. In such embodiments, as shown, the spring wire 122b can be U-shaped with a portion extending through the opening 134 of the adapter 120 and a second portion secured by the fastener 114. Referring to FIG. 6C, in another embodiment, the spring wire 122 may be a snap-fit spring wire 122c. In such embodiments, as shown, the snap-fit spring wire 122c can be snap fit onto the adapter 120. Further, as shown, at least a portion 138 of the spring wire 122c is configured to extend past the adapter 120 to engage with the latch arm member 112 of the latch mechanism 106.

One skilled in the art would understand the embodiments depicted in FIGS. 6A-6C are not limiting. Alternative embodiments of the spring wire 122 shown in FIG. 6A, for instance, may include a straight section spring wire 122a having at least two straight sections 123a. The two straight sections 123a are received through the opening 134 in the adapter 120 having a dual-stop vertex 136 configured to receive the two straight sections 123a such that the two straight sections 123a in a spaced apart manner. Accordingly, the two straight sections 123a are spaced apart and extend through the opening 134 to allow at least a portion of the latch mechanism 106, such as a proximal end of a latch arm member, to be disposed therebetween.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance assembly, comprising:
a cabinet comprising at least one wall;
an oven accessory removably coupled to the at least one wall of the cabinet via a latch assembly, the latch assembly comprising:
a latch body secured to the at least one wall of the cabinet;
a latch arm member coupled to the latch body and extending therefrom;
a pin extending through a distal end of the latch arm member, the pin movably engaged with and restricted by a path formed on an exterior surface of the oven accessory; and
a spring wire configured to engage with a proximal end of the latch arm member to limit movement of the pin within the path,
wherein, upon engaging the oven accessory with the latch assembly, the pin of the latch arm member is secured within the path formed on the exterior surface of the oven accessory to secure the oven accessory to the at least one wall of the cabinet in a locked position, and wherein, upon re-engaging the oven accessory with the latch assembly, the pin of the latch arm member is released from the path formed on the exterior surface of the oven accessory to release the oven accessory from the at least one wall of the cabinet.

2. The oven appliance assembly of claim 1, wherein the spring wire limits movement of the pin within the path to ensure the pin is positioned to enter an inlet of the path and into a locked position upon pushing the latch assembly, and wherein the spring wire further limits movement of the pin within the path to ensure that the pin exits the path upon repushing the latch assembly.

3. The oven appliance assembly of claim 1, wherein the path formed on the exterior surface of the oven accessory comprises an inlet, an outlet, a plurality of surfaces, and a recess for securing the pin of latch arm member within the path to secure the oven accessory to the at least one wall of the cabinet in the locked position.

4. The oven appliance assembly of claim 1, wherein the path formed on the exterior surface of the oven accessory comprises at least one of a carotid shape, a cordiform shape, or an asymmetrical open-loop shape.

5. The oven appliance assembly of claim 3, wherein, upon engaging the oven accessory toward the proximal end of the latch arm member, movement of the pin is guided by the plurality of surfaces until the pin contacts a first terminal surface of the path, the first terminal surface stopping movement of the pin within the path to ensure the pin is positioned to engage with the recess of the path.

6. The oven appliance assembly of claim 5, wherein, upon re-engaging the oven accessory toward the proximal end of the latch arm member, movement of the pin is guided by the plurality of surfaces until the pin contacts a second terminal surface of the path, the second terminal surface stopping movement of the pin within the path to ensure the pin is positioned to exit through the outlet of the path.

7. The oven appliance assembly of claim 1, further comprising an adapter coupled to the at least one wall of the cabinet and to the proximal end of the latch arm member, wherein the adapter comprises an opening for receiving a portion of the spring wire therethrough.

8. The oven appliance assembly of claim 7, wherein the opening of the adapter comprises a cross section such that the spring wire limits movement of the pin within the path by being limited by the cross section, the cross section having a shape comprising one of a triangular cross section, an arrowhead cross section, or a polygonal cross section having at least four sides.

9. The oven appliance assembly of claim 1, wherein the spring wire comprises at least one of a straight section spring wire, a U-shaped spring wire, or a snap-fit spring wire.

10. The oven appliance assembly of claim 1, wherein the latch arm member is pivotally coupled to the at least one wall of the cabinet to allow bidirectional movement of the pin relative to a neutral position, the spring wire configured to bias the proximal end of the latch arm member toward the neutral position to limit rotation of the pin to less than 45 degrees from the neutral position.

11. The oven appliance assembly of claim 1, further comprising a spring-loaded push rod for biasing the oven accessory away from the proximal end of the latch arm member.

12. The oven appliance assembly of claim 1, wherein the oven accessory comprises a water reservoir, the oven appliance assembly further comprising a steam-generating system in fluid communication with the water reservoir for providing steam to an interior of the cabinet during operation of the oven appliance assembly.

13. A latch assembly for removably coupling an oven accessory to at least one wall of a cabinet of an oven appliance, the latch assembly comprising:
a latch body secured to the at least one wall of the cabinet;
a latch arm member coupled to the latch body and extending therefrom;
a pin extending through a distal end of the latch arm member, the pin movably engaged with and restricted by a path formed on an exterior surface of the oven accessory; and
a spring wire configured to engage with a proximal end of the latch arm member to limit movement of the pin within the path,
wherein, upon engaging the oven accessory with the latch assembly, the pin of the latch arm member is secured within the path formed on the exterior surface of the oven accessory to secure the oven accessory to the at least one wall of the cabinet in a locked position, and wherein, upon re-engaging the oven accessory with the latch assembly, the pin of the latch arm member is released from the path formed on the exterior surface of the oven accessory to release the oven accessory from the at least one wall of the cabinet.

14. The latch assembly of claim 13, wherein the spring wire limits movement of the pin within the path to ensure the pin is positioned to enter an inlet of the path and into a locked position upon pushing the latch assembly, and wherein the spring wire further limits movement of the pin within the path to ensure that the pin exits the path upon repushing the latch assembly.

15. The latch assembly of claim 13, wherein the path formed on the exterior surface of the oven accessory comprises an inlet, an outlet, a plurality of surfaces, and a recess for securing the pin of latch arm member within the path to secure the oven accessory to the at least one wall of the cabinet in the locked position.

16. The latch assembly of claim 13, wherein the path formed on the exterior surface of the oven accessory comprises at least one of a carotid shape, a cordiform shape, or an asymmetrical open-loop shape.

17. The latch assembly of claim 13, wherein, upon engaging the oven accessory toward the proximal end of the latch arm member, movement of the pin is guided by the plurality of surfaces until the pin contacts a first terminal surface of the path, the first terminal surface stopping movement of the pin within the path to ensure the pin is positioned to engage with the recess of the path.

18. The latch assembly of claim 15, wherein, upon re-engaging the oven accessory toward the proximal end of the latch arm member, movement of the pin is guided by the plurality of surfaces until the pin contacts a second terminal surface of the path, the second terminal surface stopping movement of the pin within the path to ensure the pin is positioned to exit through the outlet of the path.

19. The latch assembly of claim 13, further comprising an adapter coupled to the at least one wall of the cabinet and to the proximal end of the latch arm member, wherein the adapter comprises an opening for receiving a portion of the spring wire therethrough.

20. The latch assembly of claim 17, wherein the opening of the adapter comprises a cross section such that the spring wire limits movement of the pin within the path by being limited by the cross section, the cross section having a shape comprising one of a triangular cross section, an arrowhead cross section, or a polygonal cross section having at least four sides.
